(19) United States
(12) Patent Application Publication
(10) Pub. No.: US 2026/0238509 A1
(43) Pub. Date: Aug. 13, 2026

(54) ONBOARD RELAY APPARATUS, RELAY METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Tatsuya NAKAJIMA, Yokkaichi-shi, Mie (JP); Yukihiro MIYASHITA, Yokkaichi-shi, Mie (JP); Hirofumi URAYAMA, Yokkaichi-shi, Mie (JP); Naoto KOBAYASHI, Yokkaichi-shi, Mie (JP); Tadashi MATSUMOTO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/153,810

(22) PCT Filed: Jan. 30, 2024
(86) PCT No.: PCT/JP2024/002803

§ 371 Date: Aug. 5, 2025

(30) Foreign Application Priority Data
Feb. 8, 2023 (JP) 2023-017361

(51) Int. Cl. H04L 12/40; G06F 40/177; H04L 41/08; H04L 45/02; H04L 45/52

(52) U.S. Cl. CPC H04L 12/40032; H04L 41/0886; H04L 45/02; H04L 45/52; G06F 40/177; H04L 2012/40215

(57) ABSTRACT

An onboard relay apparatus includes: a first memory storing original data of a plurality of relay tables usable for the relay processing, a second memory configured to store one relay table extracted from the original data, a first communication unit that includes a plurality of communication ports, configured to transmit and receive a first frame that complies with a first communication protocol, using each of the plurality of communication ports, a second communication unit configured to transmit and receive a second frame that complies with a second communication protocol, and a control unit configured to execute the relay processing related to the first frame and the second frame, and the control unit executes update processing for updating the relay table that is extracted from the original data of the first memory to the second memory based on identification information of an extension device connected to the communication port.

### CROSS-REFERENCE TO RELATED APPLICATIONS

This application is the U.S. national stage of PCT/JP2024/002803 filed on Jan. 30, 2024, which claims priority of Japanese Patent Application No. JP 2023-017361 filed on Feb. 8, 2023, the contents of which are incorporated herein.

### TECHNICAL FIELD

The present disclosure relates to an onboard relay apparatus, a relay method, and a computer program.

### BACKGROUND

JP 2021-138263A describes a technology for efficiently handling the number of types of communication protocols, in an onboard relay apparatus capable of executing processing for relaying communication frames, which involves protocol conversion between CAN (Control Area Network: registered trademark) and Ethernet (registered trademark).

JP 2021-119724A describes a technology for generating communication frames suitable for transmitting information to an ECU (Electronic Control Unit) connected to a CAN bus, in an onboard relay apparatus that performs processing for relaying communication frames, which involves protocol conversion between CAN and Ethernet.

In conventional onboard relay apparatuses, when an extension device is added or removed through a CAN communication port or the connection position thereof is changed, a maintenance person needs to manually update a relay table. For this reason, there is a problem in that changing network configurations is troublesome.

### SUMMARY

An apparatus according to one aspect of the present disclosure is an onboard relay apparatus on an extension side capable of executing relay processing of a communication frame, and includes: a first memory configured to store original data of a plurality of relay tables usable for the relay processing, a second memory configured to store one relay table extracted from the original data, a first communication unit that includes a plurality of communication ports, and is configured to transmit and receive a first frame that complies with a first communication protocol, using each of the plurality of communication ports, a second communication unit configured to transmit and receive a second frame that complies with a second communication protocol, and a control unit configured to execute the relay processing related to the first frame and the second frame, wherein the control unit executes update processing for updating the relay table that is extracted from the original data of the first memory to the second memory based on identification information of an extension device connected to the communication port.

A method according to one aspect of the present disclosure is a relay method that is executed by an onboard relay apparatus on an extension side capable of executing relay processing of a communication frame, the onboard relay apparatus including: a first memory configured to store original data of a plurality of relay tables usable for the relay processing, and a second memory configured to store one relay table extracted from the original data, the relay method includes: a step of transmitting and receiving a first frame that complies with a first communication protocol, using at least one of a plurality of communication ports, a step of transmitting and receiving a second frame that complies with a second communication protocol, a step of executing the relay processing related to the first frame and the second frame, and a step of executing update processing for updating the relay table that is extracted from the original data of the first memory to the second memory based on identification information of an extension device connected to the communication port.

A computer program according to one aspect of the present disclosure is a computer program for causing a computer to function as an onboard relay apparatus on an extension side capable of executing relay processing of a communication frame, the computer program causing the computer to function as: a first memory configured to store original data of a plurality of relay tables usable for the relay processing, a second memory configured to store one relay table extracted from the original data, a first communication unit that includes a plurality of communication ports, and is configured to transmit and receive a first frame that complies with a first communication protocol, using each of the plurality of communication ports, a second communication unit configured to transmit and receive a second frame that complies with a second communication protocol, and a control unit configured to execute the relay processing related to the first frame and the second frame, and the control unit executes update processing for updating the relay table that is extracted from the original data of the first memory to the second memory based on identification information of an extension device connected to the communication port.

An object of the present disclosure is to provide an onboard relay apparatus and the like in which network configurations can be easily changed.

### Advantageous Effects

According to the present disclosure, network configurations can be easily changed.

### BRIEF DESCRIPTION OF DRAWINGS

FIG. 1 is a network configuration diagram showing a configuration example of an onboard communication system.

FIG. 2 is a block diagram showing an example of an internal configuration of a gateway on an extension-side.

FIG. 3 is an explanatory diagram showing an example of conversion processing of a communication frame.

FIG. 4 is an explanatory diagram showing an example of relay tables on the extension side.

FIG. 5 is an explanatory diagram showing a conventional example of a method for storing and updating a relay table.

FIG. 6 is an explanatory diagram showing an embodiment of a method for storing and updating a relay table.

FIG. 7 is a flowchart showing an example of relay processing of a communication frame on the extension side.

### DETAILED DESCRIPTION OF PREFERRED EMBODIMENTS

Embodiments of the present disclosure will be listed and described below.

In a first aspect, an apparatus according to the present embodiment is an onboard relay apparatus on an extension side capable of executing processing for relaying a communication frame, and including: a first memory configured to store original data of a plurality of relay tables usable for the relay processing, a second memory configured to store one relay table extracted from the original data, a first communication unit that includes a plurality of communication ports, and is configured to transmit and receive a first frame that complies with a first communication protocol, using each of the plurality of communication ports, a second communication unit configured to transmit and receive a second frame that complies with a second communication protocol, and a control unit configured to execute the relay processing related to the first frame and the second frame, wherein the control unit executes update processing for updating the relay table that is extracted from the original data of the first memory to the second memory based on identification information of an extension device connected to the communication port.

Note that the relay processing related to the first frame and the second frame includes mutual relay between the first frame and the second frame.

With the onboard relay apparatus according to the present embodiment, the control unit executes update processing for updating the relay table that is extracted from the original data of the first memory to the second memory based on the identification information of the extension device connected to the communication port.

Therefore, it is possible to automatically update the relay table in accordance with addition or removal of an extension device or a change in the connection position thereof without manually updating the relay table, and easily change network configurations.

In a second aspect, in the onboard relay apparatus according to the present embodiment, the identification information of the extension device may be identification information of the extension device recognized as legitimate in authentication processing performed by the onboard relay apparatus or another onboard relay apparatus.

With such a configuration, update processing that uses identification information of an illegitimate extension device is not executed, and thus it is possible to preemptively prevent an illegitimate extension device from infiltrating the onboard communication system.

In a third aspect, the onboard relay apparatus according to the present embodiment, the original data may be text-based data that includes information of the plurality of relay tables, and the table updating may include processing for converting the text-based data into table format.

The reason for this is that it is difficult to determine, directly from the text-based data, one relay table that is to be extracted to the second memory, and thus it is necessary to convert the text-based data into a plurality of relay tables as pre processing of processing for determining one relay table.

In a fourth aspect, the onboard relay apparatus according to the present embodiment, the control unit may transmit, to the extension device, a message indicating that a connection cannot be established, if a data amount of the relay table that is extracted to the second memory exceeds a storage capacity for table storage in the second memory.

In this case, the extension device that has received the message indicating that a connection cannot be established performs display or outputs sound to issue a warning, and the user can thereby be notified that the extension device cannot be newly connected.

In a fifth aspect, the onboard relay apparatus according to the present embodiment, if the first communication protocol and the second communication protocol are different, the control unit may execute the relay processing that involves protocol conversion.

In this case, even when the first communication protocol and the second communication protocol are different, the first frame and the second frame can be mutually relayed appropriately.

In a sixth aspect, the onboard relay apparatus according to the present embodiment, the first communication protocol may be CAN or CAN-FD, and the second communication protocol may be Ethernet.

In this case, relay processing that involves protocol conversion can be performed on the first frame, which is a CAN or CAN-FD frame, and the second frame, which is an Ethernet frame.

In a seventh aspect, the onboard relay apparatus according to the present embodiment, identification information of the extension device may be a CAN ID.

The reason for this is that CAN IDs are used as identification information of existing devices in many cases, and thus it is preferable to adopt a CAN ID also for identification information of an extension device and ensure consistency of information.

A method according to the present embodiment is a relay method that is executed by the onboard relay apparatus according to the first to the seventh aspects. Therefore, the relay method according to the present embodiment has similar actions and effects to those of the onboard relay apparatus according to the first to the seventh aspects.

In a ninth aspect, a computer program according to the present embodiment is a computer program for causing a computer to function as the onboard relay apparatus according to the first to the seventh aspects. Therefore, the computer program according to the present embodiment has similar actions and effects to those of the onboard relay apparatus according to the first to the seventh aspects.

Embodiments of the present disclosure will be described below in detail. Note that at least some of the embodiments described below may be suitably combined.

### Configuration Example of Onboard Communication System

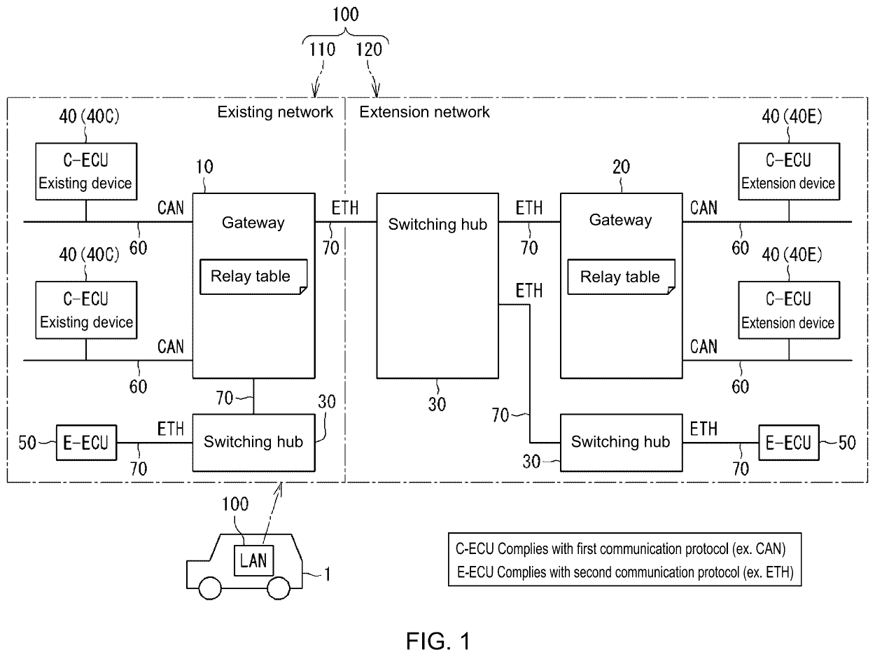

FIG. 1 is a network configuration diagram of a configuration example of an onboard communication system 100.

As shown in FIG. 1, the onboard communication system 100 according to the present embodiment is an onboard LAN (Local Area Network) built in a vehicle 1. The onboard communication system 100 includes a plurality of gateways 10 and 20, switching hubs 30, ECUs 40 and 50, and the like as communication nodes constituting a network.

The ECUs 40 and 50 are vehicle electronic control units, which control various onboard devices such as sensors and actuators in the vehicle 1.

In addition, the ECUs 40 and 50 are communication nodes constituting the onboard communication system 100, and can each be regarded, from the perspective of communication, as a type of onboard communication apparatus.

With a focus on control targets, the types of ECUs 40 and 50 include an engine control ECU, a transmission control ECU, a power steering control ECU, an air conditioning control ECU, and an AV (Audio/Visual) system control ECU.

The ECUs 40 and 50 import, into the system, measurement information from sensors (such as a speed sensor, an acceleration sensor, a temperature sensor, and a pressure sensor) connected to the ECUs 40 and 50, and control various actuators (such as an electric motor) connected to the ECUs 40 and 50, based on the measurement information.

With a focus on communication protocols, the onboard communication system 100 is a network that includes the ECUs 40 that perform communication in compliance with a “first communication protocol” and the ECUs 50 that perform communication in compliance with a “second communication protocol”.

For example, CAN (Control Area Network: registered trademark), CAN-FD (CAN with flexible data rate), LIN (Local Interconnect Network), FlexRay (registered trademark) or the like can be adopted as the first communication protocol. In the present embodiment, it is assumed that the first communication protocol is “CAN”.

The type of second communication protocol is not particularly limited as long as the second communication protocol is a communication protocol different from the first communication protocol.

However, in the present embodiment, the second communication protocol is Ethernet, which realizes a higher transmission speed than the first communication protocol. Hereinafter, Ethernet may be abbreviated as “ETH”.

The ECUs 40 are ECUs that perform communication in compliance with CAN (the first communication protocol).

In the present embodiment, a communication frame that complies with CAN is referred to as a “CAN frame” or a “first frame”, and an ECU that performs CAN communication is referred to as a “C-ECU”.

The ECUs 50 are ECUs that perform communication in compliance with ETH (the second communication protocol).

In the present embodiment, a communication frame that complies with ETH is referred to as an “Ethernet (ETH) frame” or a “second frame”, and an ECU that performs ETH communication is referred to as an “E-ECU”.

C-ECUs 40 are connected to the gateways 10 and 20 by CAN buses 60. The CAN buses 60 are communication lines each composed of high-side and low-side wires. A plurality of C-ECUs 40 can be connected to a single CAN bus 60 in a line topology.

E-ECUs 50 are connected to the gateways 10 and 20 or the switching hubs 30 by LAN cables 70. The LAN cables 70 are communication lines that conform to categories of CAT5 or higher, which can ensure a communication speed of, for example, 100 Mbps or 1 Gbps.

The gateways 10 and 20 are onboard relay apparatuses that have a function of relaying CAN communication between different CAN buses 60 and a function of relaying communication between ECUs 40 and 50 (in the present embodiment, a “C-ECU 40” and an “E-ECU 50” that use different communication protocols).

The switching hubs 30 are onboard relay apparatuses capable of relaying Ethernet frames using the L2 or L3 layer, for example. That is to say, the switching hubs 30 are onboard relay apparatuses that comply only with the first communication protocol.

As shown in FIG. 1, the onboard communication system 100 includes an existing network 110 and an extension network 120. The existing network 110 is a network built in the vehicle 1 as standard, while the extension network 120 is a network that is built in the vehicle 1 optionally. The extension network 120 may be added at the time of maintenance of the vehicle 1, for example.

Enhancing a safety function for the vehicle 1 and adding a new function desired by the user of the vehicle 1 are envisioned as examples of needs for additional installation.

In the example in FIG. 1, the existing network 110 includes, as communication nodes serving as constituent elements thereof, one existing-side gateway 10, two C-ECUs 40 (40C), one switching hub 30, and one E-ECU 50.

However, the types and the number of above communication nodes are exemplary, and the actual existing network 110 may include larger numbers of gateways 10, switching hubs 30, and ECUs 40 and 50 than those illustrated.

In the example in FIG. 1, the extension network 120 includes, as communication nodes serving as constituent elements thereof, one extension-side gateway 20, two switching hubs 30, two C-ECUs 40 (40E), and one E-ECU 50.

The types and the number of above communication nodes are also exemplary, and, for example, the gateway 20 may be connected to the gateway 10 using a LAN cable 70 and the E-ECU 40 on the extension side may be connected to the gateway 10, using the LAN cable 70 without using the switching hubs 30.

As described above, the C-ECUs 40 of the onboard communication system 100 include the C-ECUs 40C already included in the existing network 110, and the C-ECUs 40E that can be adopted as communication nodes of the extension network 120 later.

Therefore, in the following description, the C-ECUs 40C that are constituent elements of the existing network 110 may be referred to as “existing devices 40C”, and the C-ECUs 40E that can be constituent elements of the extension network 120 may be referred to as “extension devices 40E”.

### Configuration Example of Extension-Side Gateway

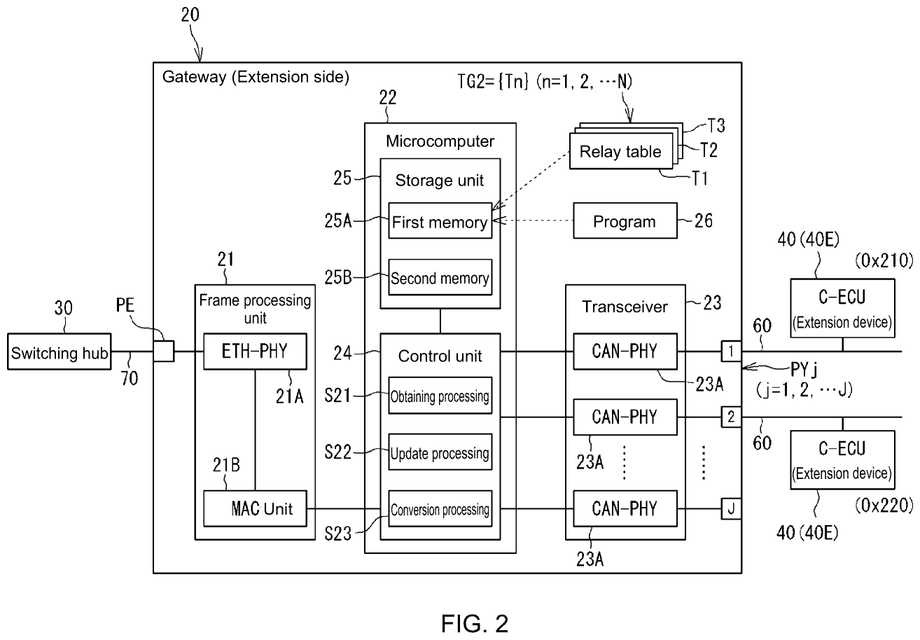

FIG. 2 is a block diagram showing an example of an internal configuration of the extension-side gateway 20.

As shown in FIG. 2, the extension side gateway 20 includes a frame processing unit 21 for ETH communication, a microcomputer 22, and a transceiver 23 for CAN communication. The extension-side gateway 20 also includes a plurality of communication ports PYj (j=1, 2, . . . , J) for CAN and one communication port PE for ETH.

The frame processing unit 21 corresponds to a “second communication unit” that transmits and receives an ETH frame (second frame) that complies with the second communication protocol.

The frame processing unit 21 is constituted by one or more integrated circuits that execute signal processing in compliance with Ethernet, and includes a PHY unit 21A and a MAC unit 21B. The PHY unit 21A is an integrated circuit that performs signal modulation and demodulation in compliance with Ethernet, and is provided in correspondence with the Ethernet communication port PE.

The MAC unit 21B is an integrated circuit that executes signal processing related to a MAC (Media Access Control) layer of Ethernet.

The MAC unit 21B is constituted by an FPGA (Field Programmable Gate Array) and the like, and is electrically connected to the microcomputer 22 and the PHY unit 21A.

The microcomputer 22 is a microcomputer that includes a control unit 24 and a storage unit 25.

The control unit 24 is a computation processing device that includes one or more CPUs (Central Processing Units). The control unit 24 may also include another integrated circuit such as an FPGA.

The control unit 24 reads a computer program 26 stored in a first memory 25A of a storage unit 25 to a second memory 25B, and executes information processing required for communication relay in accordance with the read program 26. This information processing will be described in detail later.

The storage unit 25 includes the first memory 25A and the second memory 25B.

The first memory 25A is an auxiliary storage device that includes a non-volatile memory such as an EPROM (Erasable Programmable ROM), an EEPROM (Electrically Erasable Programmable ROM), or a flash ROM (Read Only Memory). The first memory 25A may be a non-rewritable ROM (Read Only Memory).

The second memory 25B is a main storage device that includes a volatile memory such as an SRAM (Static RAM) or a DRAM (Dynamic RAM).

Information that is extracted to the second memory 25B includes, in addition to the computer program 26, later-described relay tables Tn that are used for relay processing that involves protocol conversion.

In addition to the computer program 26, the first memory 25A stores, as an archive, original data of a relay table group TG2 that includes a plurality of relay tables Tn (n=1, 2, . . . , N) that may be required when relay of a communication frame that involves protocol conversion is performed.

The data format of original data may be the table format of the plurality of relay tables Tn as is, or may be a text-based data format that includes information related to the plurality of relay tables Tn of the relay table group TG2.

However, in order to determine a relay table Tn that is to be extracted from the text-based original data to the second memory 25B, there is a need to perform processing for converting text-based data into table format.

CSV (Comma Separated Values), XML (Extensible Markup Language), JSON (JavaScript Object Notation), and the like can be adopted as the text-based data format. Note that the data content of the relay table group TG2 will be described later.

The transceiver 23 corresponds to a “first communication unit” that transmits and receives CAN frames (first frames) in compliance with the first communication protocol.

The transceiver 23 is a transmitting/receiving device that performs signal processing of the physical layer in compliance with CAN, and includes a plurality of PHY units 23A. The PHY units 23A are integrated circuits that perform signal conversion at the CAN L1 level, and are provided for the respective CAN communication ports PYj (j=1, 2, . . . , N).

Specifically, each PHY unit 23A decodes a differential signal from the CAN bus 60 into a digital signal, and outputs the digital signal to the control unit 24. Conversely, the PHY unit 23A generates a CAN differential signal from a digital signal input from the control unit 24, and transmits the CAN differential signal to the communication port PYj (the CAN bus 60).

Information processing that is executed by the control unit 24 of the microcomputer 22 includes at least the following three types of processing.

S21: authentication processing of an extension device 40E

S22: update processing of a relay table

S23: protocol conversion processing

The authentication processing S21 is processing for determining whether or not an extension device (C-ECU) 40E newly connected to the gateway 20 is a legitimate communication node.

Key exchange using a message authentication code, a digital signature, or the like, which is performed with the extension device 40E newly added to the CAN bus 60 that is currently connected to the communication port PYj, can be adopted as the authentication processing S21.

The update processing S22 is processing for updating a relay table Tn that is to be extracted from original data of the relay table group TG2 (={Tn}: n=1, 2, . . . , N) that is an archive stored in the first memory 25A, to the second memory 25B.

The update processing S22 is executed, for example, based on the identification information (e.g., the CAN IDs) of all of the extension devices 40E that have been recognized as legitimate in the authentication processing S21.

Specifically, the control unit 24 determines which relay table Tn among the plurality of relay tables Tn is to be extracted to the second memory 25B, based on the identification information of the authenticated extension devices 40E. The control unit 24 then updates one relay table Tn to be used for relay processing, by extracting data of the determined relay table Tn to the second memory 25B.

The conversion processing S23 is processing for bidirectionally executing protocol conversion between CAN and ETH, by referencing the one relay table Tn stored in the second memory 25B and updated in the update processing S22.

Specifically, the control unit 24 performs “first conversion” for converting an ETH frame input from the frame processing unit 21 into a CAN frame, and outputs the CAN frame obtained through the conversion to the transceiver 23.

In this case, the control unit 24 determines which PHY unit 23A included in the transceiver 23 the CAN frame obtained through the conversion is to be output to (which CAN bus 60 the CAN frame is to be output to), based on the one relay table Tn extracted to the second memory 25B.

Conversely, the control unit 24 performs “second conversion” for converting a CAN frame input from one of the PHY units 23A included in the transceiver 23 into an ETH frame, and outputs the ETH frame obtained through conversion to the frame processing unit 21.

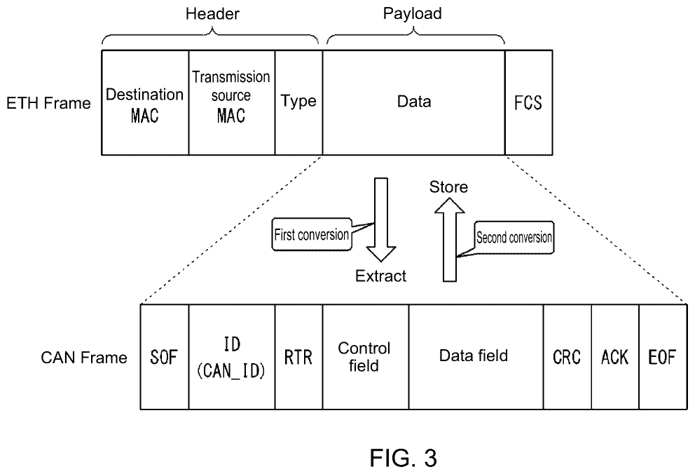

FIG. 3 is an explanatory diagram showing an example of communication frame conversion processing S13 that is executed by the control unit 24 of the microcomputer 22.

As shown in FIG. 3, here, a technique for storing all the data of a CAN frame in the payload of an ETH frame is adopted.

In this case, the control unit 24 extracts a CAN frame from the payload of an ETH frame input from the frame processing unit 21, and thereby performs “first conversion” from the ETH frame to the CAN frame.

In addition, the control unit 24 generates an ETH frame in which the payload stores a CAN frame input from the transceiver 23, and thereby performs “second conversion” from the CAN frame to the ETH frame.

The control unit 24 of the microcomputer 22 executes processing for transmitting a communication frame obtained through conversion. Transmission processing that is performed by the control unit 24 includes the following processing.

ETH transmission: processing for outputting an ETH frame obtained through conversion to the frame processing unit 21.

CAN transmission: processing for outputting a CAN frame obtained through conversion to the transceiver 23. In this case, an output destination of the CAN frame (i.e., a transmission port PYj) is determined in accordance with a rule for the relay table Tn.

### Specific Example of Relay Table Group on Extension Side

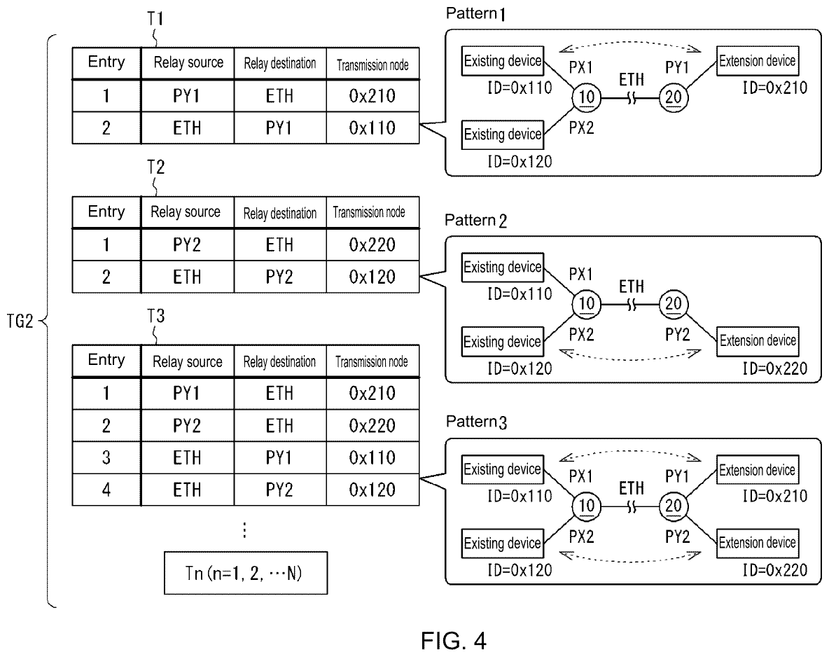

FIG. 4 is an explanatory diagram showing an example of the relay table group TG2 on the extension side.

As shown in FIG. 4, the relay tables Tn (n=1, 2, . . . , N) on the extension side include matrix-format data in which “relay source”, “relay destination” and “transmitting node” are defined for each entry. A relay source represents a type of receiving port for communication frames, and a relay destination represents a type of transmission port for communication frames. A transmission node represents identification information of a transmission source.

In the present embodiment, assuming addition or removal of an extension device 40E on the extension side, for example, “information transmission rules” that include the following multiple rules are adopted.

Rule 1: the third least significant digit of the identification information (CAN ID) of an existing device is set to “1”.

Rule 2: the third least significant digit of the identification information (CAN ID) of an extension device is set to “2”.

Rule 3: Communication nodes whose identification information (CAN IDs) have the same value in the second least significant digit exchange information.

In the present embodiment, it is assumed that, in the existing-side gateway 10, one existing device (ID=0x110) is connected to a CAN communication port PX1, and one existing device (ID=0x120) is connected to a CAN communication port PX2. Furthermore, topologies of the following three patterns for adding one or more extension devices to the extension side gateway 20 from the existing state are envisioned.

Pattern 1: one extension device (ID=0x210) is connected to PY1.

Pattern 2: one extension device (ID=0x220) is connected to PY2.

Pattern 3: one extension device (ID=0x210) is connected to PY1, and one extension device (ID=0x220) is connected to PY2.

The relay table T1 in the relay table group TG2 in FIG. 4 is a table that is used for the pattern 1. In a case of the pattern 1, it suffices for a relay path (indicated by the dashed arrow in FIG. 4) between the extension device with the ID “0x210” and the existing device with the ID “0x110” to be defined in accordance with the rule 3.

For this reason, the relay table T1 includes an entry 1 for defining a transmission port and receiving port for relaying a communication frame from the extension device with the ID “0x210” to the existing device with the ID “0x110”, and an entry 2 for defining a transmission port and a receiving port in a reversed case.

The relay table T2 in the relay table group TG2 in FIG. 4 is a table that is used for the pattern 2. In a case of the pattern 2, it suffices for a relay path (indicated by the dashed arrow in FIG. 4) between the extension device with the ID “0x220” and the existing device with the ID “0x120” to be defined in accordance with the rule 3.

For this reason, the relay table T2 includes an entry 1 for defining a transmission port and receiving port for relaying a communication frame from the extension device with the ID “0x220” to the existing device with the ID “0x120”, and an entry 2 for defining a transmission port and a receiving port in a reversed case.

The relay table T3 in the relay table group TG2 in FIG. 4 is a table that is used for the pattern 3. In a case of the pattern 3, it suffices for a relay path (indicated by the dashed arrow in FIG. 4) between the extension device with the ID “0x210” and the existing device with the ID “0x110” and a relay path (indicated by the dashed arrow in FIG. 4) between the extension device with the ID “0x220” and the existing device with the ID “0x120” to be defined based on the rule 3.

For this reason, the relay table T3 includes an entry 1 for defining a transmission port and receiving port for relaying a communication frame from the extension device with the ID “0x210” to the existing device with the ID “0x110” and an entry 3 for defining a transmission port and a receiving port in a reversed case.

The relay table T3 also includes an entry 2 for defining a transmission port and receiving port for relaying a communication frame from the extension device with the ID “0x220” to the existing device with the ID “0x120”, and an entry 4 for defining a transmission port and a receiving port in a reversed case.

A relay table Tn that is included in the relay table group TG2 is individually defined for each addition pattern that can be envisioned in advance, and is not limited to the three types illustrated in FIG. 4.

For example, on the extension side, when a pattern 4 is envisioned in which the extension device with the ID “0x210” is connected to PY2 instead of PY1, the relay table T4 corresponding to the pattern 4 is also included in the relay table group TG2.

If the number of extension devices to be added is K (K is a natural number of 3 or larger), it is sufficient that a plurality of topologies for addition patterns when k (k=3, 4, . . . , K) extension devices are connected to PYj (j=1, 2, . . . , J) are specified and a relay table Tn is defined for each of the specified addition patterns.

In this manner, the plurality of relay tables Tn are defined in one-to-one correspondence with a plurality of addition patterns when a user such as a vehicle manufacturer adds one or more extension devices to communication ports PYj of the gateway 20 in predetermined topologies.

Problem with Conventional Gateway and Solutions Thereof

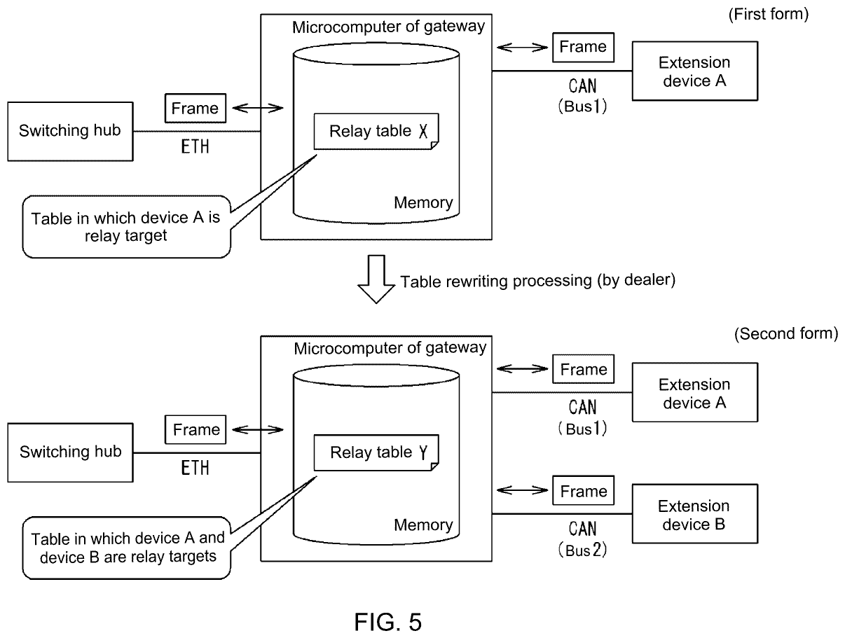

FIG. 5 is an explanatory diagram showing a conventional example of a method for storing and updating relay tables X and Y.

As shown in FIG. 5, the relay table X is a table defined such that only an extension device A is set as a relay target, and the relay table Y is a table defined such that the extension device A and an extension device B are set as relay targets.

Unlike LANs in buildings such as office and home LANs, in onboard LANs, the frequency of addition or removal of a communication node such as a C-ECU or a change in the connection position thereof is relatively low.

For this reason, conventional gateways that perform relay processing that involves protocol conversion are designed such that only one of the relay tables X and Y is stored in the memory of the microcomputer.

Therefore, as shown in FIG. 5, when the connection form is changed from a “first form” in which the extension device A is connected to a CAN bus 1 to a “second form” in which the extension device B is additionally connected to a CAN bus 2, processing for rewriting data from the relay table X to the relay table Y is required.

Such rewriting between the relay tables X and Y needs to be performed manually, for example, by a maintenance person of the vehicle 1 connecting a management terminal (such as a laptop PC) to the gateway using a monitoring tool such as a command line, and thus there is a problem in that the processing is troublesome. For example, in the case of gateway 10 of the existing network 110, such rewriting between relay tables is necessary.

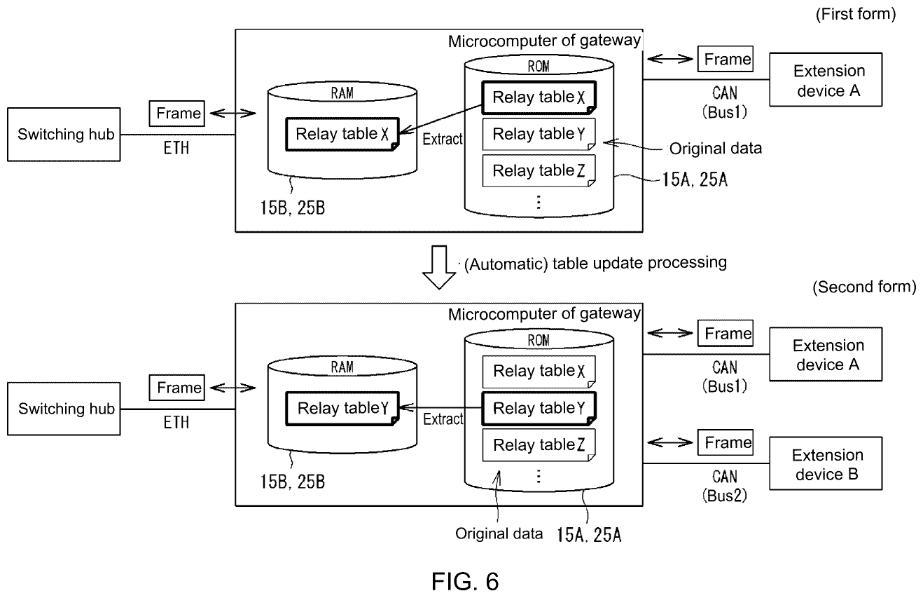

FIG. 6 is an explanatory diagram showing an embodiment of a method for storing and updating relay tables X, Y, and Z.

Also in FIG. 6, the relay table X is a table defined such that only the extension device A is set as a relay target, and the relay table Y is a table defined such that the extension device A and the extension device B are set as relay targets.

In addition, the relay table Z is a table that is used for a connection form in which an extension device (not illustrated) other than the extension device A and the extension device B is added.

As described above, in the present embodiment, the first memory 25A of the microcomputer 22 stores original data of the relay table group TG2 that includes a plurality of relay tables, namely the relay tables X, Y, and Z for respective addition patterns that can be envisioned.

In addition, the relay table X (or Y) stored in the second memory 25B is updated by being fully extracted from the original data based on the identification information of the extension devices A and B that are currently connected to the extension-side gateway 20.

Therefore, as shown in FIG. 6, when the connection form is changed from the “first form” in which the extension device A is connected to the CAN bus 1 to the “second form” in which the extension device B is additionally connected to the CAN bus 2, the relay table X stored in the second memory 25B is updated to the relay table Y.

Such updating of the relay table X to the relay table Y can be automatically executed by the microcomputer based on the identification information of the newly connected extension device B, for example.

In this manner, with the gateway 20 according to the present embodiment, the original data of the relay table group TG2 that is a set of the relay tables X, Y, and Z for the respective addition patterns that can be envisioned is stored in the first memory 25A of the microcomputer 22, and the relay table Y that is to be extracted to the second memory 25B is determined in accordance with the identification information of the extension devices A and B and the like, and thus the relay tables X, Y, and Z used for relay processing can be automatically updated through plug-and-play.

For this reason, it is possible to add and remove the extension devices A and B or change the connection position thereof without manually rewriting the relay tables X, Y, and Z, and thus there is an advantage that network configuration can be easily changed.

In addition, by performing CAN transmission in accordance with the relay tables X, Y, and Z, CAN frames are relayed only to the CAN buses to which the extension devices A and B are connected, not through broadcasting, and thus there is the advantage of leading to a reduction in the bus load and improvement of the security.

Furthermore, only one of the relay tables X and Y required for the current connection form of one or more extension devices is extracted to the second memory 25B, and thus there is the advantage that it is possible to reduce the storage capacity of the second memory 25B.

### Processing for Relaying Communication Frame on Extension Side

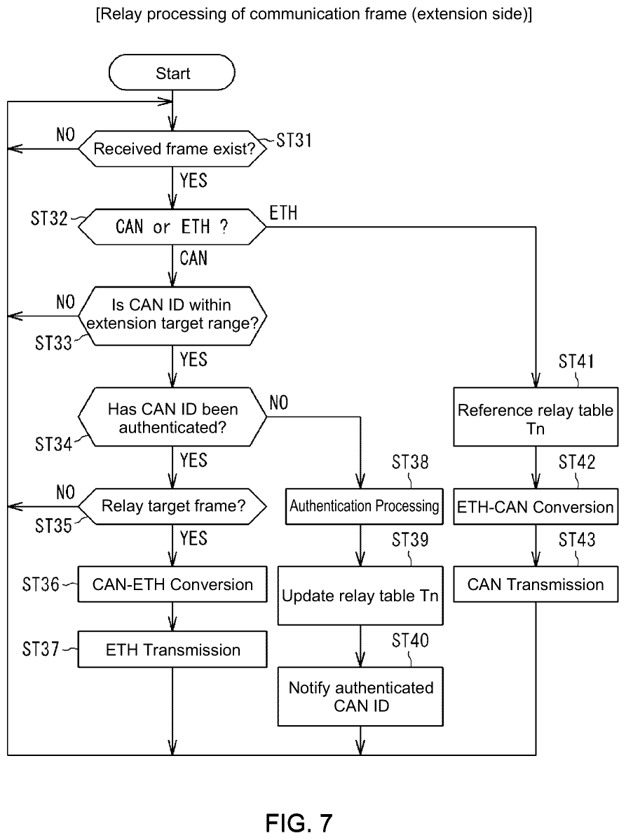

FIG. 7 is a flowchart showing an example of processing for relaying a communication frame on the extension side, which is executed by the control unit 24 of the extension side gateway 20.

Relay processing in FIG. 7 is processing for relaying a communication frame that is used for information exchange between an existing device (C-ECU) 40C and an extension device (C-ECU) 40E, and is performed using the relay table group TG2 (FIG. 4), and relay between CAN buses 60 that do not require protocol conversion is not included.

As shown in FIG. 7, the control unit 24 of the gateway 20 is monitoring the presence or absence of a received frame (step ST31), and when a received frame is detected, the control unit 24 determines whether the received frame is a CAN frame or an ETH frame (step ST32).

If the determination result in step ST32 is “CAN”, the control unit 24 determines whether or not the value of the CAN ID included in the CAN frame is within an extension target range (step ST33).

The extension target range refers to a numerical value range (for example, 0×100 to 0×400) of the CAN ID allocated to the extension device 40E in advance.

If the determination result in step ST33 is negative, the control unit 24 skips steps ST34 to ST40, and returns the procedure to before step ST31.

The reason for this is that the transmission source of the CAN frame in which the value of the CAN ID is outside the extension target range is not the extension device 40E that was envisioned in advance for future extension, and thus relay processing cannot be performed whichever relay table Tn included in the relay table group TG2 is used.

If the determination result in step ST33 is affirmative, the control unit 24 determines whether or not the CAN ID included in the CAN frame has been authenticated (step ST34).

If the determination result in step ST34 is affirmative, the control unit 24 determines whether or not the CAN frame is a relay target frame of relay from CAN to ETH (step ST35). The relay target frame refers to a CAN frame having a CAN ID included in the relay table Tn that is currently selected.

If the determination result in step ST35 is negative, the control unit 24 skips steps ST36 and ST37, and returns the procedure to before step ST31.

The reason for this is that a CAN ID that is not present in the current relay table Tn may be a CAN ID of a communication frame from an unauthorized transmission source, and thus it is not preferable to perform relay processing based on the relay table Tn.

If the determination result in step ST35 is affirmative, the control unit 24 performs processing for converting the received CAN frame from CAN into ETH (step ST36).

The above conversion processing corresponds to the second conversion for storing a received CAN frame in the payload of an ETH frame (see FIG. 3).

Next, the control unit 24 executes transmission processing of the ETH frame obtained through conversion (step ST37), and then returns the procedure to before step ST31. The above transmission processing is processing for outputting the ETH frame obtained through conversion to the frame processing unit 21.

If the determination result in step ST34 is negative, the control unit 24 executes authentication processing on the unauthenticated extension device 40E (step ST38). Through information exchange during this authentication processing, the control unit 24 obtains the CAN ID of the new extension device 40E.

Next, the control unit 24 performs update processing of the relay table Tn using the CAN ID of the authenticated extension device 40E (step ST39).

The above update processing is performed based on the values of all the CAN IDs that have been authenticated to this point. Specifically, the update processing in step ST39 includes the following processes, for example.

Process 1: all of the authenticated CAN IDs, including the CAN ID authenticated this time, are read out from the memory.

Process 2: at least one relay table Tn in which the CAN ID read out in the process 1 is included in a field “transmission node” is extracted from the relay table group TG2.

Process 3: if one relay table Tn was extracted in the process 2, the extracted relay table Tn is determined as a relay table Tn to be extracted to the second memory 25B.

Process 4: if a plurality of relay tables Tn were extracted in the process 2, a relay table Tn in which the port numbers of a plurality of PYjs that are currently in operation match a plurality of port numbers included in the field “transmission node” is determined as the relay table Tn to be extracted to the second memory 25B.

Note that, if the relay table group TG2 (original data) is stored in the first memory 25A as text-based data, processing for generating a plurality of relay tables Tn in table format from the original data is added as a process preceding the process 1.

Next, the control unit 24 notifies the existing-side gateway 10 of the CAN ID authenticated this time (step ST40), and then returns the procedure to before step ST31.

Specifically, the control unit 24 generates an Ethernet control frame (for example, an Ethernet OAM frame) that includes the authenticated CAN ID and is addressed to the gateway 10, and outputs the generated control frame to the frame processing unit 21.

If the determination result in step ST32 is “ETH”, the control unit 24 references the current relay table Tn (step ST41), and performs processing for converting the received ETH frame from ETH into CAN (step ST42).

The above conversion processing corresponds to the first conversion (see FIG. 4) for extracting a CAN frame from the payload of the received ETH frame.

Next, the control unit 24 executes transmission processing of the CAN frame obtained through the conversion (step ST43), and then returns the procedure to before step ST31. The above transmission processing includes the following procedures, for example.

Procedure 1: an entry in which the value of the CAN ID read out from the CAN frame obtained through conversion is recorded in the field “transmitting node” is extracted from the relay table Tn.

Procedure 2: the port number of PYj is read from the field “relay destination” of the extracted entry, and the CAN frame obtained through conversion is output to the CAN PHY unit 23A corresponding to this port number.

### FIRST MODIFIED EXAMPLE

In the above embodiment, the control unit 24 of the microcomputer 22 of the extension side gateway 20 may determine whether or not the data amount in the relay table Tn to be extracted to the second memory 25B exceeds the storage capacity for table storage of the second memory 25B, for example, and transmit, to the extension device 40E, a CAN frame that includes a message indicating that a connection cannot be established if the data amount exceeds the storage capacity.

In this case, if the extension device 40E that has received the above message displays a warning or outputs sound to indicate that a connection cannot be established, the user can be notified that the extension device 40E cannot be newly connected.

### SECOND MODIFIED EXAMPLE

In the above embodiment, CAN IDs (i.e., the CAN base IDs) are used as identification information used for “transmission node” of the relay tables Tn, but the identification information of a transmission node may be another identifier.

For example, identification information of a transmission node may be any information that can individually identify the device, such as a product ID allocated to the ECU by the manufacturer or a serial number that is a sequential number allocated to the product by the manufacturer.

In addition, when a product ID, a serial number, or the like is used as identification information of a transmission node, a CAN control area or extension ID can be adopted as a definition area, for example.

However, in the existing network 110, a CAN ID is used as the identification information of the existing device 40C in many cases. For this reason, from the perspective of ensuring consistency between the existing side and the extension network side, it is preferable to use CAN IDs of the existing device 40C and the extension device 40E as identification information thereof.

### THIRD MODIFIED EXAMPLE

In the above embodiment, a CAN ID may be defined as identification information of a data type of a transmission target, not as identification information of a transmission node (transmission source).

In this case, the relay table Tn may have a format that includes the fields “relay source”, “relay destination”, and “data type”. With such a configuration, the relay table Tn is a table for defining which CAN bus 60 of a relay destination the transmission target is to be transmitted to.

### FOURTH MODIFIED EXAMPLE

In the above embodiment, types of first communication protocol and second communication protocol include not only a combination of CAN and ETH, but also the following combination examples.

Combination example 1: a combination of CAN and USB (Universal Serial Bus: “USB” is a registered trademark). In this case, a configuration may be adopted in which CAN is used as the first communication protocol and USB is used as the second communication protocol, or vice versa.

Combination example 2: a combination of USB and ETH. In this case, a configuration may be adopted in which USB is used as the first communication protocol and ETH is used as the second communication protocol, or vice versa.

### FIFTH MODIFIED EXAMPLE

In the above embodiment, the first communication protocol and the second communication protocol do not necessarily need to be communication protocols of different types such as CAN and ETH, and the same type of protocol may be used, for example, both may be CAN, USB, or ETH.

In this case, the control unit 24 of the gateway 20 does not need to perform protocol conversion processing of a communication frame when relaying the communication frame (for example, FIG. 3).

### OTHER MODIFIED EXAMPLES

The embodiment disclosed herein is exemplary in all respects and is not limiting. The scope of the present disclosure is defined not by the above embodiment, and includes all modifications that are within configurations described in the claims and equivalents thereof.

In the above embodiment, the onboard relay apparatus may be a relay apparatus that is configured by housing the gateway 20 and one or more switching hubs 30 in one case, and includes a plurality of Ethernet ports.

In the above embodiment, the microcomputer 22 of the gateway 20 executes both relay processing between the CAN buses 60 that does not involve protocol conversion and relay processing that involves protocol conversion between CAN and ETH, but a configuration may also be adopted in which the relay processing is shared and executed by different microcomputers (integrated circuits).

In the above embodiment, the existing device 40C and the extension device 40E do not necessarily need to be ECUs, and may be onboard devices other than ECUs that can independently perform CAN communication, such as sensors, actuators, or the like that have a CAN communication function.

1-9. (canceled)

10. An onboard relay apparatus on an extension side capable of executing relay processing of a communication frame, the onboard relay apparatus comprising:
a first memory configured to store original data of a plurality of relay tables usable for the relay processing;
a second memory configured to store one relay table extracted from the original data;
a first communication unit that includes a plurality of communication ports, and is configured to transmit and receive a first frame that complies with a first communication protocol, using each of the plurality of communication ports;
a second communication unit configured to transmit and receive a second frame that complies with a second communication protocol; and
a control unit configured to execute the relay processing related to the first frame and the second frame,
wherein the control unit executes update processing for updating the relay table that is extracted from the original data of the first memory to the second memory if identification information of an extension device connected to the communication port is identification information included in an extension target range allocated in advance.

11. The onboard relay apparatus according to claim 10, wherein the identification information of the extension device is identification information of the extension device recognized as legitimate in authentication processing performed by the onboard relay apparatus or another onboard relay apparatus.

12. The onboard relay apparatus according to claim 10, wherein the original data is text-based data that includes information of the plurality of relay tables, and the table updating includes processing for converting the text-based data into table format.

13. The onboard relay apparatus according to claim 10, wherein the control unit transmits, to the extension device, a message indicating that a connection cannot be established, if a data amount of the relay table that is extracted to the second memory exceeds a storage capacity for table storage in the second memory.

14. The onboard relay apparatus according to claim 10, wherein, if the first communication protocol and the second communication protocol are different, the control unit executes the relay processing that involves protocol conversion.

15. The onboard relay apparatus according to claim 10, wherein the first communication protocol is CAN or CAN-FD, and the second communication protocol is Ethernet.

16. The onboard relay apparatus according to claim 10, wherein identification information of the extension device is a CAN ID.

17. A relay method that is executed by an onboard relay apparatus on an extension side capable of executing relay processing of a communication frame,
the onboard relay apparatus including:
a first memory configured to store original data of a plurality of relay tables usable for the relay processing, and
a second memory configured to store one relay table extracted from the original data,
the relay method comprising:
a step of transmitting and receiving a first frame that complies with a first communication protocol, using at least one of a plurality of communication ports;
a step of transmitting and receiving a second frame that complies with a second communication protocol;
a step of executing the relay processing related to the first frame and the second frame; and
a step of executing update processing for updating the relay table that is extracted from the original data of the first memory to the second memory if identification information of an extension device connected to the communication port is identification information included in an extension target range allocated in advance.

18. A computer program for causing a computer to function as an onboard relay apparatus on an extension side capable of executing relay processing of a communication frame,
the computer program causing the computer to function as:
a first memory configured to store original data of a plurality of relay tables usable for the relay processing,
a second memory configured to store one relay table extracted from the original data,
a first communication unit that includes a plurality of communication ports, and is configured to transmit and receive a first frame that complies with a first communication protocol, using each of the plurality of communication ports,
a second communication unit configured to transmit and receive a second frame that complies with a second communication protocol, and
a control unit configured to execute the relay processing related to the first frame and the second frame,
wherein the control unit executes update processing for updating the relay table that is extracted from the original data of the first memory to the second memory if identification information of an extension device connected to the communication port is identification information included in an extension target range allocated in advance.
